(19) United States
(12) Patent Application Publication
(10) Pub. No.: US 2026/0233451 A1
(43) Pub. Date: Aug. 13, 2026

(54) COMPONENT FOR AN EXTRUSION LINE

(71) Applicant: battenfeld-cincinnati Germany GmbH, Bad Oeynhausen (DE)

(72) Inventors: Heinrich Dohmann, Bad Oeynhausen (DE); Henning Stieglitz, Minden (DE)

(21) Appl. No.: 17/767,478

(22) PCT Filed: Oct. 13, 2020
(86) PCT No.: PCT/EP2020/078810

§ 371 Date: May 19, 2025

(30) Foreign Application Priority Data
Oct. 15, 2019 (DE) 10 2019 127 707.8

(51) Int. Cl. B29C 48/87; B29C 48/25; B29C 48/30; B29C 48/694; B33Y 80/00

(52) U.S. Cl. CPC B29C 48/87; B29C 48/2511; B29C 48/3001; B29C 48/694; B33Y 80/00

(57) ABSTRACT

A component of an extrusion line, the component being configured to cool a melt, configured to homogenize a melt, or configured for distributing the melt, consists of a plurality of individual parts. The component is constructed in a computer-assisted manner. Computer-assisted manufacturing data predominate for the component, and the component is additively manufactured on the basis of the data. The component manufactured in this manner fulfills at least one of the following functionalities: uniform distribution of the melt over the circumference, thermal homogenization of the melt over the circumference, mechanical homogenization of the melt over the circumference, cooling of the melt over the circumference, retention of a supporting element for the internal displacement of the melt, the component being a screen basket, a melt cooler, or a part of a spiral mandrel distributor.

### CROSS REFERENCE TO RELATED APPLICATIONS

This application is a U.S. National Phase application under 35 U.S.C. § 371 of International Application No. PCT/EP2020/078810, filed on Oct. 13, 2020, and claims benefit to German Patent Application No. DE 10 2019 127 707.8, filed on Oct. 15, 2019. The International Application was published in Germany on Apr. 22, 2021 as WO 2021/074170 A 1 under PCT Article 21(2).

### FIELD

The invention relates to a component of an extrusion line, in particular a die or a part thereof, the component being provided in particular for cooling the melt and/or for homogenizing the melt and/or for distributing the melt, the component having a complex design and consisting of a plurality of individual parts. The invention furthermore relates to an associated method.

### BACKGROUND

DE 10 2010 051 732 A1 describes a device for distributing a ductile mass of plastics material in an extrusion die, in particular a pipe extrusion die, comprising one or more flow ducts having at least one melt inlet and one melt outlet, at least one cooling element being arranged between the melt inlet and melt outlet in the flow duct, the mass of plastics material being able to flow around the cooling element, a forced-distribution element for the fine-distribution of the melt being arranged radially in the flow duct, the cooling element being arranged in or on the forced-distribution element.

To produce pipes, the cylindrical flow of plastics melt generated by an extruder has to be reshaped into a melt flow in the shape of an annulus using a downstream die. To do so, it is important that, in the die, the melt flow originating from the extruder is converted into the corresponding annular flow by a centrally arranged mandrel. A device of this kind is proposed in DE 103 15 906.

Nowadays, short extrusion lines are often required. This can only be achieved if the cooling of the extruded profiles is optimized. In the best-case scenario, the melt will have already cooled down in the die to such an extent that it is still deformable but the melt temperature is significantly lower than after leaving the extruder.

In this context, DE 10 2007 050 291 proposes dividing the melt in the die; the individual strands are cooled and then brought back together.

In the prior art, EP 0 593892 A1 further discloses a profile die for extruders having temperature-control elements that can be activated separately and influence the flow behavior of the material. The temperature-control elements are arranged downstream of the screw of the extruder and upstream of the profiling region of the die in the flow duct of the material, in such a way that the temperature of the extruded material can be increased in selected regions of the cross section. It is thus possible to influence the wall thickness of the profile, even in the case of complicated cross sections and different profiling parts not equipped with temperature-control elements.

DE 103 15 906 A1 discloses a device for distributing a ductile mass of plastics material in an extrusion die, in particular a pipe extrusion die, comprising a melt inlet and at least one melt outlet, a pre-distribution element first being arranged between the melt inlet and melt outlet, and a fine-distribution element being arranged thereafter, the pre-distribution element being configured as a mandrel and comprising a main duct that is in fluid communication with at least one secondary duct, the secondary duct discharging helically in the circumferential surface of the mandrel.

However, the inventors have recognized that all of these dies are difficult to produce in process terms, since a multiplicity of individual parts have to be laboriously produced and then very laboriously interconnected. Complex cooling ducts have to be combined into one structure having a plurality of ducts and “merged” to form an overall component. Internal parts around which melt flows and which are intended for cooling the melt in turn have to be connected to external parts such that a cooling medium can flow through them. In this process, however, none of the cooling medium flowing through the cooling ducts is permitted to reach the melt, so the aforementioned connections have to be completely sealed, which pushes the limits of technical feasibility due to the complexity, and associated poor accessibility, of the points to be connected.

### SUMMARY

In an embodiment, the present disclosure provides a component of an extrusion line, the component being configured to cool a melt, configured to homogenize a melt, or configured for distributing the melt, which consists of a plurality of individual parts. The component is constructed in a computer-assisted manner. Computer-assisted manufacturing data predominate for the component, and the component is additively manufactured on the basis of the data. The component manufactured in this manner fulfills at least one of the following functionalities: uniform distribution of the melt over the circumference, thermal homogenization of the melt over the circumference, mechanical homogenization of the melt over the circumference, cooling of the melt over the circumference, retention of a supporting element for the internal displacement of the melt, the component being a screen basket, a melt cooler, or a part of a spiral mandrel distributor.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a typical extrusion line;

FIG. 2 is a longitudinal section through a component according to the invention;

FIG. 3 is a section through the component according to the invention in accordance with the sectional line in FIG. 2;

FIG. 4 shows an alternative configuration in relation to FIG. 3;

FIGS. 5a and 5b show an alternative configuration of the component in the extrusion die;

FIG. 6 shows the component by itself;

FIG. 7 shows the view from FIG. 6 without baffles;

FIG. 8 shows an enlarged detail of FIG. 6;

FIG. 9 shows an enlarged detail of FIG. 7;

FIGS. 10a and 10b show the detail from FIG. 8 in part-section; and

FIGS. 11a and 11b show the detail from FIG. 6 in a further part-section.

### DETAILED DESCRIPTION

Aspects of the present invention simplify the production of complex components in the field of extrusion so as to be able to minimize production costs and the production time required for the components, and a corresponding method.

One or more embodiments of the present invention provide a component that is constructed in a computer-assisted manner, computer-assisted manufacturing data predominate for the component, and the component is additively manufactured on the basis of the data, the component manufactured in this manner fulfilling at least one of the following functionalities: uniform distribution of the melt over the circumference, thermal homogenization of the melt over the circumference, mechanical homogenization of the melt over the circumference, cooling of the melt over the circumference, retention of a supporting element for the internal displacement of the melt.

There are a multiplicity of possible components that can be produced according to the invention. For example, these can be a melt cooler, a spiral mandrel distributor, a combination of the two, or also any other combination.

From the components constructed in a computer-assisted manner using computer assisted design (CAD), manufacturing data are generated in turn in a computer-assisted manner, which data are then used for the additive manufacture of the components, similarly to the production of parts by way of computer numerical control (CNC) machines. In additive manufacturing, successive material layers are deposited, thus generating a three-dimensional object.

By way of additive manufacturing, also known as 3D printing, very complex components can be produced since there is no need to take account of accessibility of connection points when assembling individual components. The conventional considerations of the producibility of the component are now irrelevant too since any complex configuration can be produced using this method.

One or more embodiments of the present invention provide a method for producing a component for an extrusion line, to construct the component in a computer-assisted manner, and to generate computer-assisted manufacturing data therefrom in order to additively produce the component on the basis of the data, the component manufactured in this manner fulfilling at least one of the following functionalities: uniform distribution of the melt over the circumference, thermal homogenization of the melt over the circumference, mechanical homogenization over the circumference, cooling of the melt over the circumference.

According to a development, to produce a component for an extrusion line, the design of the component is altered by way of computer-assisted simulations until such a point as the extrusion process is optimized, before the computer-assisted manufacturing data are generated.

Advantageously, the flow behavior of the melt and/or the degree of homogenization of the melt and/or the dwell time of the melt in corner regions of the component are tested in the simulation.

The design is thus altered and a simulation of the flow behavior of the melt is continually tested until as many of the above-described functionalities as possible are optimally obtained.

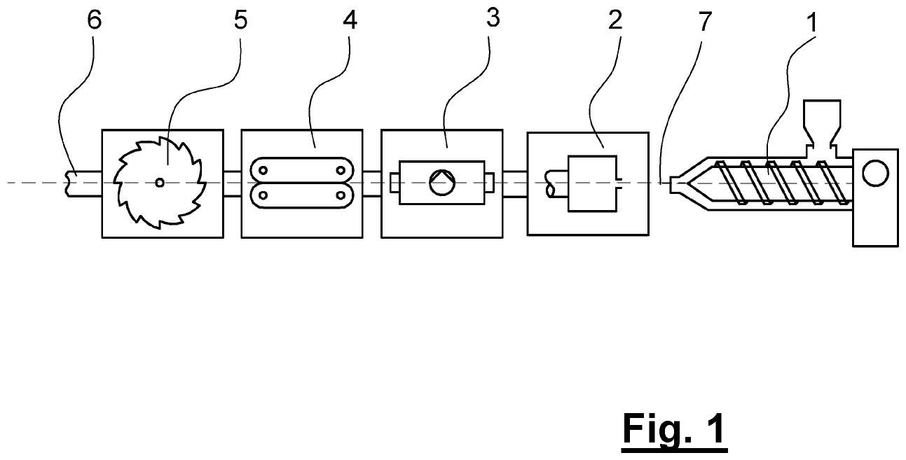

FIG. 1 shows an extrusion line, used for profile extrusion, be it for the production of window profiles or pipes. It shows an extruder 1 in which plastics material is melted and continuously fed into the extrusion die 2 for shaping. Following the extruder 1 is a calibration and cooling station 3; depending on the profile, additional cooling stations can be inserted. A drawing device 4 follows the cooling stations. To cut the continuous profiles 6 to the desired length, a cutting device 5 is arranged thereafter. The extrusion axis is marked by reference sign 7.

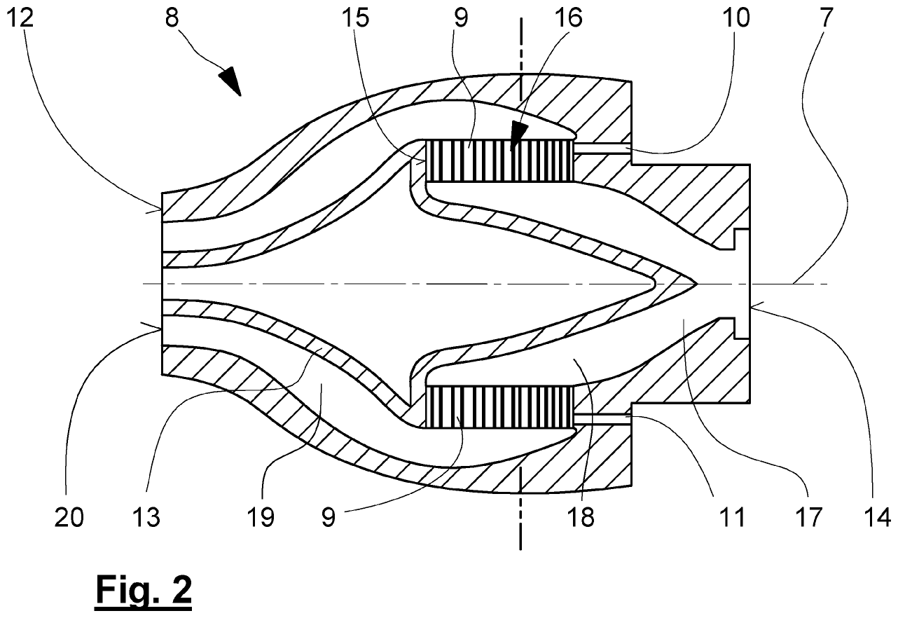

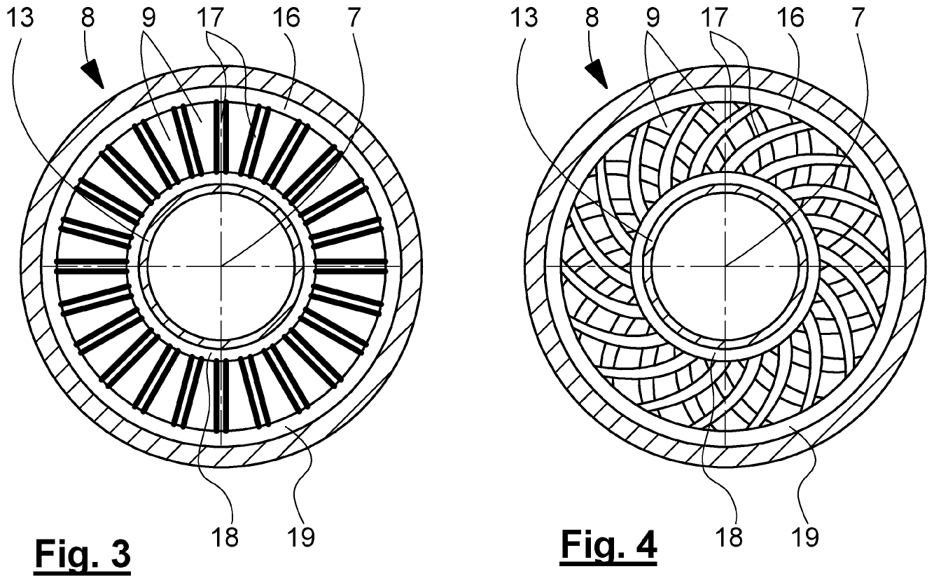

FIG. 2 is a schematic section through an additively manufactured component 8 according to the invention. The component 8 has a melt duct 17, which extends from the melt inlet 14 to the melt outlet 20. A supporting element 13, in this case a mandrel in an extrusion die, displaces the melt in the interior of the component 8 such that the melt is distributed over the circumference so as to be fed to a mixing and cooling structure 16. The supporting element 13 is arranged in the component 8 on the mixing and cooling structure 16 and is thus retained in the interior of the component 8. In this case, the connection point 15 is designated as a separate reference sign for illustration purposes only; owing to the additive production method, it is not a connection in the classic sense, but rather a single piece. The melt is thus guided through the mixing and cooling structure 16, where it is thermally and mechanically homogenized, and cooled. The mixing and cooling structure 16 has cooling ducts 9 around which the melt flows. The cooling ducts 9 have an entry 10 and an exit 11, via which the cooling medium flows through the cooling ducts 9 from the outside of the component 8. Various media, such as water, air, or special coolants, are used as the cooling medium. By way of the end-face flange 12, the component 8 can be connected to other components. The sectional line for the embodiment examples shown in FIGS. 3 and 4 is marked by the dash-dot line.

FIG. 3 is a section through the schematic illustration of the component 8 in accordance with the sectional line from FIG. 2. The first melt sub-duct 18 extends from the melt inlet 14, via the melt duct 17 in the mixing and cooling structure 16, and further to the melt outlet 20 via the second melt sub-duct 19. The cooling ducts 9 in the mixing and cooling structure 16 have an entry 10 and an exit 11 for a cooling medium. The extrusion axis is marked by reference sign 7.

FIG. 4 shows an alternative embodiment of the mixing and cooling structure 16; in this figure too, like components are denoted by like reference numerals.

Extrusion is a commonly used method for processing plastics materials. It is a continuous process in which pipes made of plastics material can be produced, among other products.

In pipe extrusion, a melt strand is given the relevant shape using a die. Next, the pre-shaped melt tube has to be calibrated to the relevant external diameter and cooled. Lastly, the resultant pipe is drawn through the extrusion line using a caterpillar pull-off system and then cut to corresponding transport lengths by a cutting apparatus.

The dimensional and visual quality of the pipe depends substantially on the quality of the pipe die. The better the melt is distributed over the circumference and the more thermally and mechanically homogeneous the melt is over the entire cross section, the more uniform the pipe geometry and surface configuration can be in the downstream calibration and cooling operation. Existing, mechanically producible melt distributors, mixing components or cooling components can implement the desired properties only to a limited extent or only separately. Static mixers are known from the state of the art; for example, the German Wikipedia page for static mixers discusses the design, functioning and dimensioning of these mixers, as well as their advantages and disadvantages. By way of an excerpt therefrom, it is pointed out at this juncture that static mixers have some advantages over dynamic mixers since they are cost-effective, do not take up much space, and are maintenance-free, depending on their model. One very compact mixer mentioned is the Sulzer model, in which corrugated fins intersect each other or which is formed having a multiplicity of scaffold-like ribs arranged in a crisscross manner. This design, however, has high pressure losses.

Another static mixer is the Kenics mixer, about which the aforementioned Wikipedia page states: “It consists of plates twisted through 180°. Each turn is shifted through 90° compared with the previous one and has the opposite direction of rotation.”

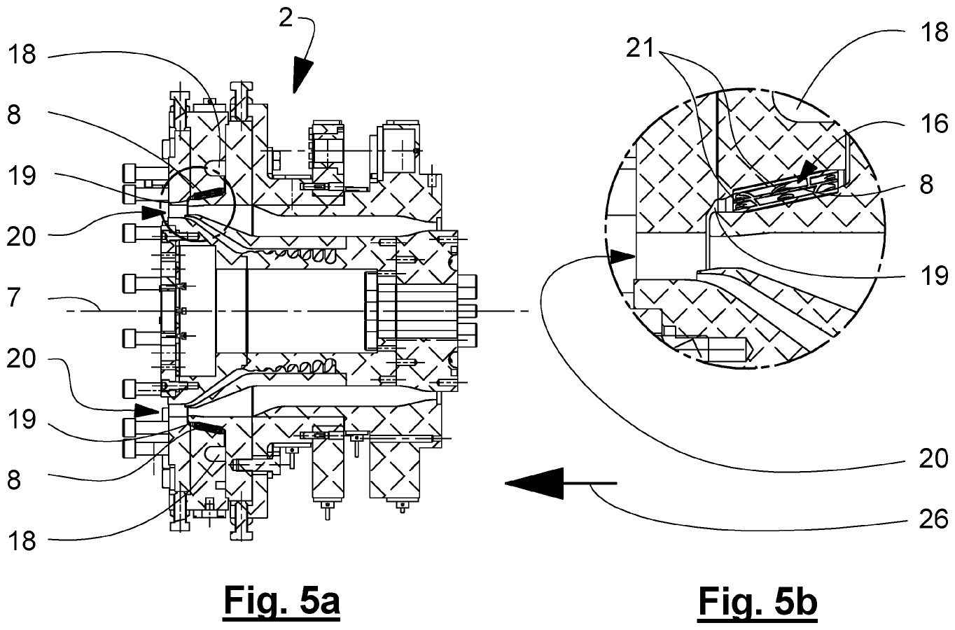

This Kenics mixer design is the basis for a further alternative embodiment of the component 8 and is described in more detail in FIG. 5-11. This embodiment is a development of a static pipe extrusion melt distributors in which a temperature-control option is additionally incorporated in the die.

FIG. 5 shows a portion of a section through the extrusion die 2. The melt duct extends along the extrusion axis 7 from a first melt sub-duct 18, via the component 8 according to the invention, into the second melt sub-duct 19 and to the melt outlet 20. FIG. 5a shows the component 8 in enlarged form. The component 8 has a mixing and cooling structure 16, which consists of a multiplicity of ribs 21. The extrusion direction is denoted by reference sign 26.

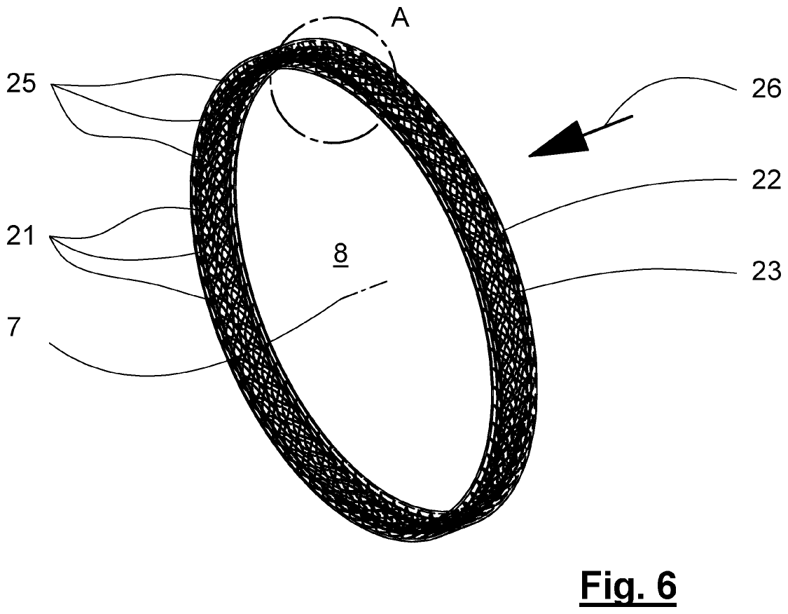

FIG. 6 is a three-dimensional view of the component 8 by itself. In this figure too, the ribs 21 of the mixing and cooling structure can be seen, which are arranged distributed over the entire circumference. There is a first region 22 and there is a second region 23, in which the ribs 21 are arranged. In turn, the two regions are arranged equidistantly from one another and the ribs 21 in the first region 22 are offset from the ribs 21 in the second region 23. The individual regions are separated from one another by baffles 25. In this figure too, the extrusion direction is denoted by reference sign 26.

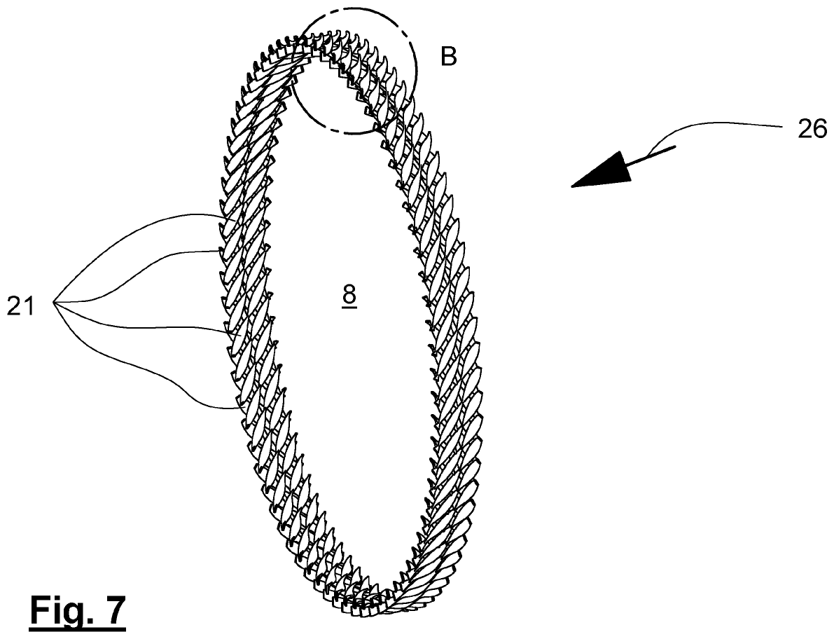

FIG. 7 again shows the component 8, but in this figure the baffles 25 separating the regions 22 and 23 from one another have been removed in order to illustrate the twisted ribs 21.

It should additionally be noted that further regions can also be arranged equidistantly from the regions 22 and 23. In this context, it is not necessary for the degree of twist of the ribs 21 to repeat like in one region 22 or 23; what is crucial is that the ribs 21 are twisted with respect to the ribs in an adjacent region. The same applies to the twist of the rib 21 itself; this degree of twist can also be different from region to region. It may also be advantageous to deliberately guide the melt, which is traversing the region, from one region to an adjacent region. In the embodiment examples described and shown, the baffles 25 separating the regions are configured such as to prevent the melt from overflowing. However, by deliberately making holes or positioning one or more lugs, the melt can be intentionally made to overspill. This promotes thorough mixing and/or homogenization.

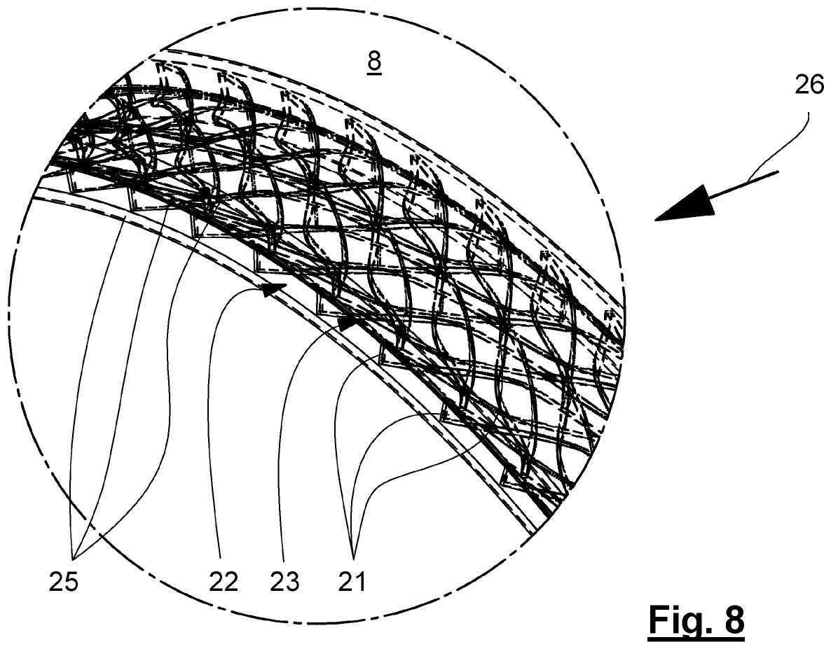

To illustrate the specific design, FIG. 8 is an enlarged view A from FIG. 6. In this figure too, it is possible to see the ribs 21, which are twisted on themselves and are arranged in the first region 22 and in the second region 23 in each case. As already set out, the two regions are separated from one another by baffles 25.

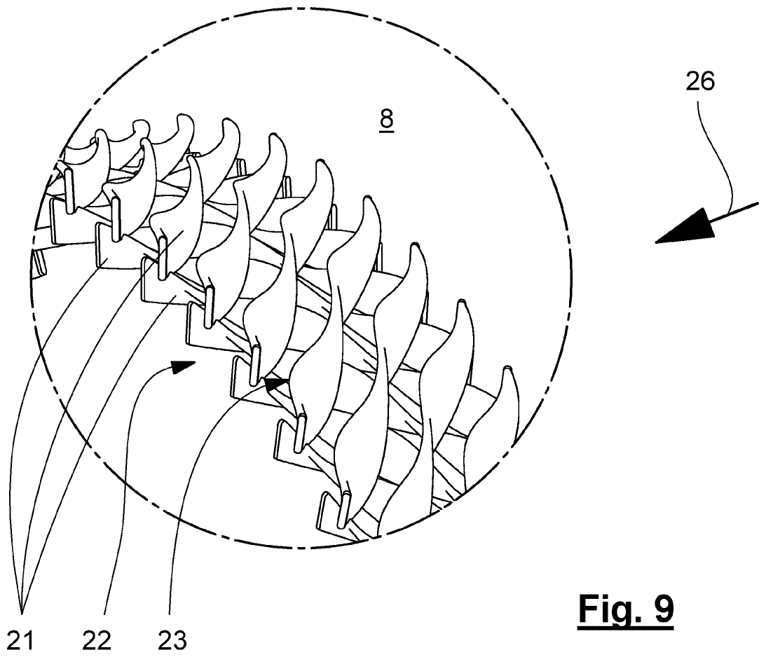

FIG. 9 likewise shows an enlarged detail B from FIG. 7, showing the component 8 without the baffles 25. Clearly visible are the ribs 21 that are twisted on themselves and are arranged in the first region 22 in a manner offset from the ribs 21 in the second region 23.

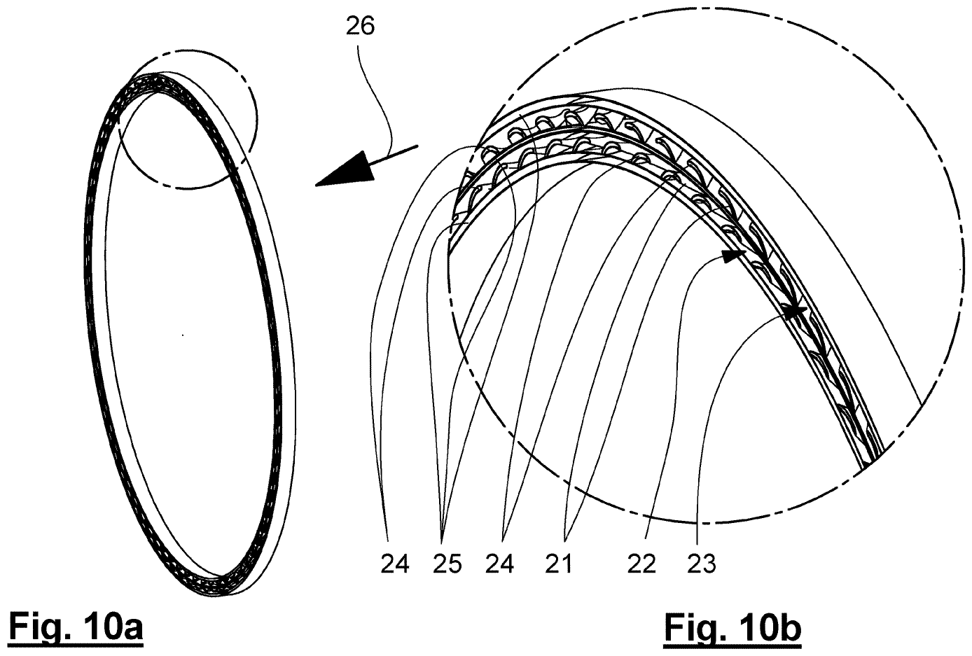

The illustration according to FIG. 10 corresponds to the detail according to FIG. 8, but in this case the component 8 is shown cut open transversely to the extrusion direction 26. It is clear from this sectional view that the ribs 21 have a cavity 24. FIG. 10a shows the cut-open component 8 and FIG. 10b shows an enlarged detail thereof. The advantage of configuring the ribs 21 to have a cavity 24 is that a cooling medium can flow through the ribs 21. In this case too, air, water, oil, or other media suitable for cooling can be used as the cooling medium. Depending on the configuration of the connection to the cavities 24 in the ribs 21 by way of a central feed line or a plurality of duct-like feed lines, it is also possible to tailor the intensity of the cooling via the ribs 21 within the overall component 8 by having the coolant flow through individual ribs 21 to a greater or lesser extent. In this case too, the first region 22, the second region 23 and the baffles 25 can be seen.

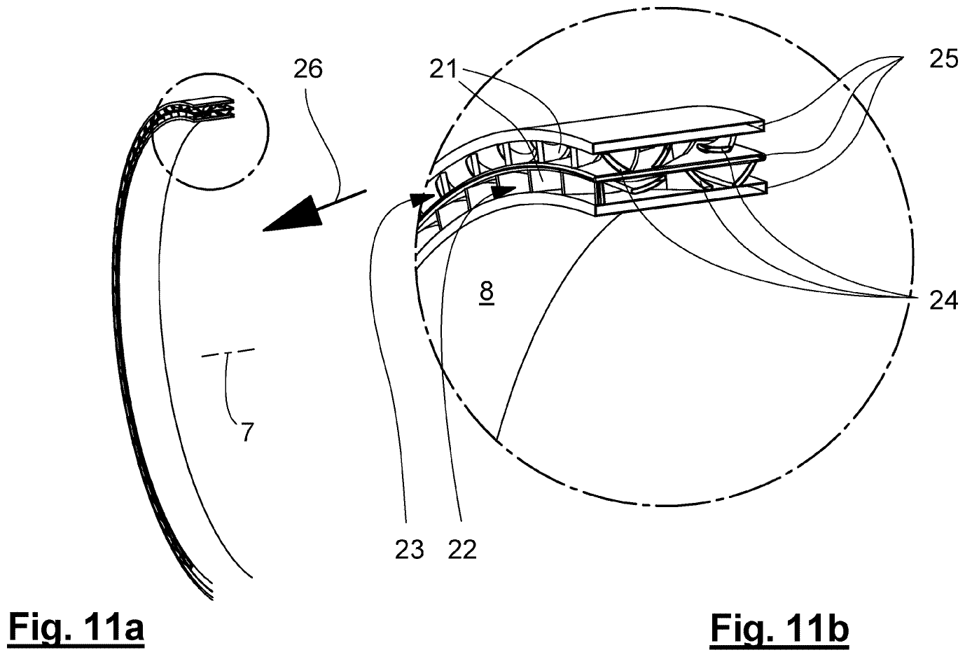

FIG. 11 is likewise a section through the component 8, but in this case a section along the extrusion axis 26 has been selected. In this figure too, the twisted ribs 21 in the regions 22 and 23 as well as the baffles 25 can be seen again. It is clear to see that the ribs 21 have a cavity 24.

This component according to the invention can be generated using new manufacturing technologies, for example additive metal laser sintering, and has the following properties on the melt in the extrusion die:
Uniform distribution of the melt over the circumference
Thermal and mechanical homogenization over the entire cross section
Cooling of the melt in the die
Short dwell time range (short color change times)
Moderate pressure build-up

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Extruder
2 Extrusion die
3 Calibration and cooling tank
4 Drawing device
5 Cutting device
6 Profile
7 Extrusion axis
8 Component of 2
9 Cooling duct in 8
10 Cooling medium entry in 9
11 Cooling medium exit in 9
12 Connection flange
13 Mandrel
14 Melt inlet
15 Fastening of 13
16 Mixing and cooling structure
17 Melt duct
18 First melt sub-duct of 14
19 Second melt sub-duct leading to 20
20 Melt outlet
21 Ribs of 16
22 First region of 16
23 Second region of 16
24 Cavity in 21
25 Baffle in 16
26 Extrusion direction

1-10. (canceled)

11. A component of an extrusion line, the component being configured to cool a melt, configured to homogenize a melt and/or for distributing the melt, the component consisting of a plurality of individual parts, wherein the component is constructed in a computer-assisted manner, computer-assisted manufacturing data predominate for the component, and the component is additively manufactured on the basis of the data, the component manufactured in this manner fulfilling at least one of the following functionalities: uniform distribution of the melt over the circumference, thermal homogenization of the melt over the circumference, mechanical homogenization of the melt over the circumference, cooling of the melt over the circumference, retention of a supporting element for the internal displacement of the melt, the component being a screen basket, a melt cooler, or a part of a spiral mandrel distributor.

12. The component according to claim 11, wherein the component is a combination of the screen basket and the melt cooler.

13. The component according to claim 11, wherein the component is a combination of the screen basket with the spiral mandrel distributor, of the melt cooler with the spiral mandrel distributor, or of the screen basket and the spiral mandrel distributor.

14. The component according to claim 11, wherein the component comprises ribs that are twisted on themselves, the ribs being uniformly distributed over the circumference of the component, the ribs being arranged in at least two regions, and the ribs in the first region being twisted with respect to the ribs in the second region.

15. The component according to claim 14, wherein the ribs are configured as hollow bodies having a cavity.

16. A method for producing a component for an extrusion line, the method comprising:
construction the component in a computer-assisted manner;
generating computer-assisted manufacturing data from the computer-assisted construction of the component;
additively producing the component on the basis of the computer-assisted manufacturing data, wherein the additively produced component fulfills at least one of the following functionalities: uniform distribution of the melt over the circumference, thermal homogenization of the melt over the circumference, mechanical homogenization over the circumference, or cooling of the melt over the circumference.

17. The method for producing the component for the extrusion line according to claim 16, wherein the design of the component is altered by way of computer-assisted simulations until such a point as the extrusion process is optimized, before the computer-assisted manufacturing data are generated.

18. The method according to claim 17, wherein the flow behavior of the melt, the degree of homogenization of the melt, or the dwell time of the melt in corner regions of the component are tested in the simulation.

19. The method according to claim 17, wherein the component comprises ribs that are twisted on themselves are configured to influence the flow of the melt and the ribs have a cavity through which a cooling medium flows, the volume flow rate in the feed lines to the cavities in the ribs being influenced by means, whereby the intensity of the cooling within the overall component is configured to be different.

20. The component of claim 11, wherein the component is a die or a part of the die.
